(19) United States
(12) Patent Application Publication
(10) Pub. No.: US 2003/0174657 A1
(43) Pub. Date: Sep. 18, 2003

(54) Method, system and computer program product for voice active packet switching for IP based audio conferencing

(76) Inventor: Wenlong Qin, San Jose, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 10/100,206

(22) Filed: Mar. 18, 2002

(51) Int. Cl. H04L 12/16; H04Q 11/00

(52) U.S. Cl. 370/260; 370/270

(57) ABSTRACT

Methods, systems and computer program products for performing voice conferencing over a data network, such as an internet protocol (IP) network are provided. The conferencing is for use in environments including N incoming channels and N outgoing channels. Each of the N incoming channels is associated with a corresponding one of the N outgoing channels, where N≧3. A different audio packet is received over each of the N incoming channels. The energy level of each of the different audio packets is determined so that a first highest energy packet and second highest energy packet can be identified. Also identified are the incoming channels over which the first highest and second highest energy packets are received. Next, the highest energy packet is sent to each of the N outgoing channels except an outgoing channel associated with incoming channel over which the highest energy packet was received. The second highest energy packet is sent to the outgoing channel associated with the incoming channel over which the highest energy packet was received.

### BACKGROUND OF THE INVENTION

1. Field of the Invention

The present invention relates internet protocol (IP) based audio conferencing. The present invention provides, among other things, a useful tool for software developers to develop audio conferencing type applications.

2. Description of the Related Art

Conferencing has long been recognized as an essential business tool that greatly increases productivity and communication. The need for rapid communication between geographically dispersed customers and employees, buyers and sellers, production/development teams, etc. has resulted in an increased demand for conferencing.

Today, the networking world is moving towards an “all-IP” universe, taking conferencing and multimedia communications applications with it. As more and more companies and individual become reliant on computers, IP based audio conferencing services will become more and more popular.

Prior methods and systems for performing IP based audio conferencing have been unsatisfactory for a number of reasons. As will be explained below, prior methods and systems perform extensive format conversions that required significant system resources. For example, many traditional prior systems use audio mixing that requires the decoding of all incoming audio packets from a G.711 or G.723.1 format to a 16-bit linear audio signal. Once in the 16-bit linear audio signal format, the audio from multiple channels are mixed using any of a number of different types of complex algorithms. After audio mixing, all outgoing audio signals must be encoded from 16-bit linear audio signals to G.711 or G.723.1 audio packets. For software solution IP based audio conferencing, the conferencing system's capacity (i.e., usable channels) is significantly limited due to the significant amount of time and resources required to perform the coding and decoding (i.e., packet format conversion) and audio mixing.

In addition to experiencing capacity problems and system resource problems, prior methods and systems for performing IP based audio conferencing have experienced poor voice quality. The poor voice quality is caused by the multiple packet format conversions required in the prior methods and systems. The poor voice quality is often also due to the audio mixing that is performed.

FIG. 1 shows a high level functional block diagram of a traditional audio Multipoint Conferencing Unit (MCU) 100 that performs audio mixing for a plurality of channels (i.e., n channels). As shown, each of a plurality (n) of incoming G.711 or G.723.1 audio packets D1(in), D2(in) . . . Dn(in) are received by a corresponding packet-to-linear converter 102₁, 102_{2 . .} 102ₙ, which converts the incoming audio packets D1(in), D2(in) . . . Dn(in) from G.711 or G.723.1 formatted packets to 16-bit linear audio signals S1, S2 . . . Sn. The 16-bit linear audio signals S1, S2 . . . Sn are then mixed together at audio conference mixer (ACM) 104 in accordance with an appropriate algorithm. ACM 104 then outputs a plurality (n) of 16-bit linear signals S-S1, S-S2 . . . S-Sn, each of which contain the audio information of all the other incoming channels except its own channel. Each 16-bit linear signal S-S1, S-S2 . . . S-Sn is then received by a corresponding linear-to-packet converter 106₁, 106₂ . . . 106ₙ, which converts the linear signals to outgoing G.711 or G.723.1 audio packets D1(out), D2(out) . . . Dn(out).

As is apparent from the above description, the traditional audio mixing shown in FIG. 1 requires decoding of all incoming audio packets from G.711 or G.723.1 to 16-bit linear audio signals. Then, after audio mixing, all outgoing audio signals are encoded from 16-bit linear audio signals back to G.711 or G.723.1 packets. For software solution IP based audio conferencing, if a great deal of processing time and resources are used in coding and decoding (packet format conversion) and audio mixing, the conferencing system capacity (i.e., usable channels) is significantly reduced.

There is a need for improved methods and systems for IP based audio conferencing that overcome some or all of the above mentioned limitations and disadvantages.

### BRIEF SUMMARY OF THE INVENTION

The present invention is directed to methods, systems and computer program products for performing audio (e.g., voice) conferencing over data networks, such as internet protocol (IP) networks. According to an embodiment, the conferencing method is for use in an environment including N incoming channels and N outgoing channels. Each of the N incoming channels is associated with a corresponding one of the N outgoing channels, where N≧3. A different audio packet is received over each of the N incoming channels. Each of the different audio packets is received from a different conference participant. The energy level of each of the different audio packets is determined so that a first highest energy packet and second highest energy packet can be identified. Also identified are the incoming channels over which the first highest and second highest energy packets are received. Next, the highest energy packet is sent to each of the N outgoing channels except an outgoing channel associated with incoming channel over which the highest energy packet was received. The second highest energy packet is sent to the outgoing channel associated with the incoming channel over which the highest energy packet was received. These steps are repeated as additional audio packets are received.

Two things are accomplished by sending the second highest energy level packet (rather then the first highest energy level packet) over the outgoing channel associated with the incoming channel over which the highest energy audio packet was received. First, this enables the loudest end user (i.e., conference participant) to hear the second loudest end user. Thus, the loudest speaker may choose to stop speaking so that the second loudest speaker becomes the loudest speaker and is heard by the rest of the end users of the conference. Second, this prevents the loudest speaker from hearing an echo, which can be annoying to the speaker.

To estimate the energy level of each different audio packet, each audio packet is converted to a linear digital signal. The amplitudes of the linear signals are estimated to thereby estimate the energy level of each packet. It is noted that these packet-to-linear format conversions are performed primarily to determine the energy levels of the packets. There is no mixing of the linear signals. Rather, packets that are not reformatted (i.e., packets in there original format as received) are sent back to conference participants.

An advantage of embodiments of the present invention is that conversions from linear audio signals (e.g., 16-bit linear) back to packets (e.g.,G.711 or G.723.1 encoded packets) are eliminated, significantly reducing the use of system resources. Additionally, audio mixing is eliminated. That is, the audio data of the packets that are sent to the outgoing channels are never mixed with other audio data from other packets. This avoids audio distortions that can occur during mixing. This also significantly reduces processing time and the amount of system resources required to perform conferencing. Additionally, the voice quality is significantly improved because each end user can only hear one channel's audio (e.g., voice) at one time.

### BRIEF DESCRIPTION OF THE DRAWINGS/FIGURES

Features of the present invention will become more apparent from the detailed description set forth below when taken in conjunction with the drawings in which like reference characters identify the same or similar elements throughout and wherein:

FIG. 1 is a functional block diagram of a traditional audio Multipoint Conferencing Unit (MCU) that performs audio mixing for a plurality of channels;

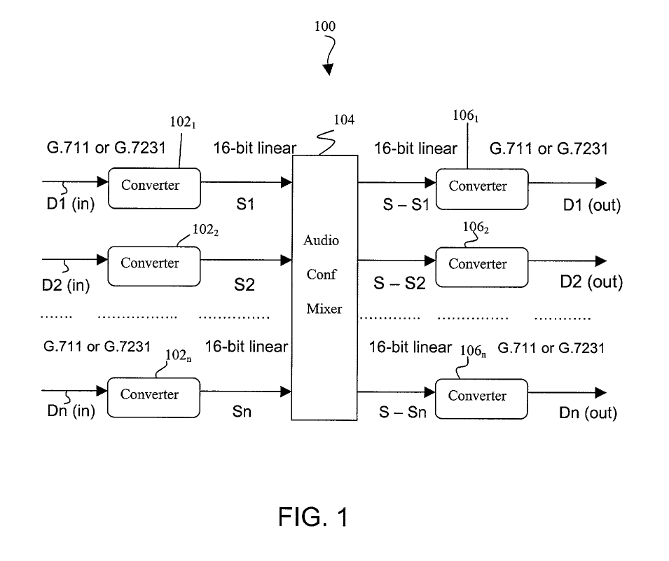

FIG. 2 is a functional block diagram of an audio MCU including a plurality of voice active software packet switching (VASPS) modules, in accordance with an embodiment of the present invention;

FIG. 3 is a functional block diagram of one of the VASPS modules from FIG. 2, in accordance with an embodiment of the present invention;

FIG. 4 is a functional block diagram showing additional details of the energy comparator of FIG. 3, according to an embodiment of the present invention;

FIG. 5 is a functional block diagram of an exemplary IP based audio conferencing (IPC) system in which embodiments of the present invention can be useful;

FIG. 6 is a functional block diagram illustrating the MCU/IVR Server of FIG. 5, according to an embodiment of the present invention;

FIG. 7 is a flow diagram that is useful for describing methods of conferencing according to embodiments of the present invention; and

FIG. 8 is a functional block diagram of a computer system useful for implementing features of the present invention.

### DETAILED DESCRIPTION OF THE INVENTION

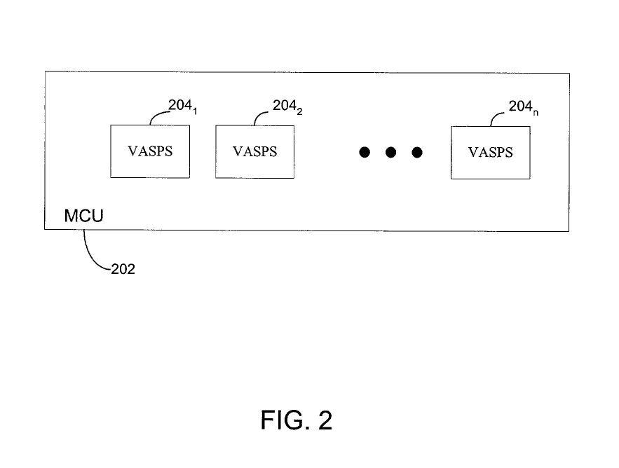

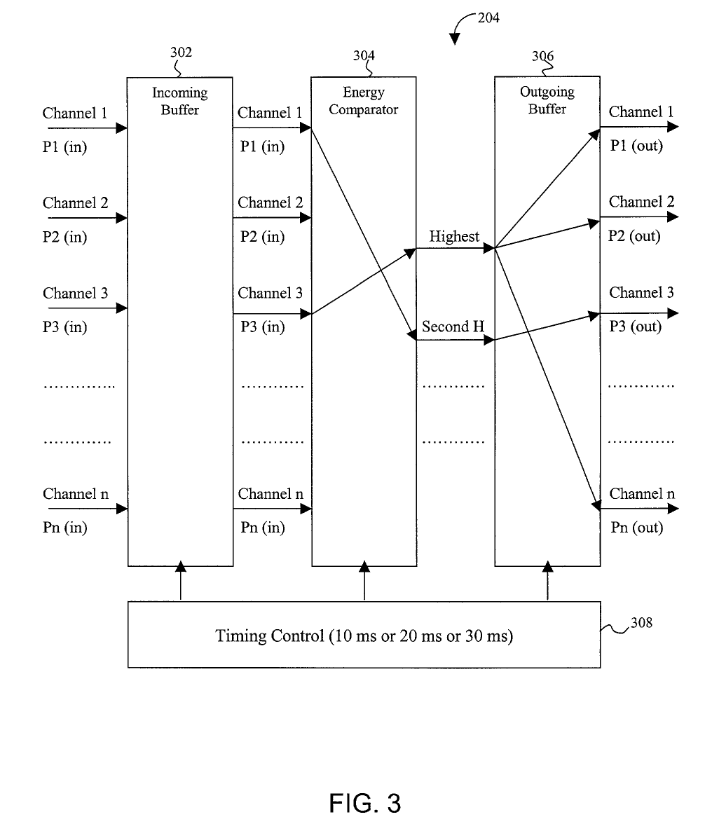

An exemplary embodiment of the present invention shall now be explained beginning with a discussion of the functional block diagram of FIG. 2. FIG. 2 shows a multipoint conferencing unit (MCU) 202 that includes a plurality of (e.g., 32) voice active software packet switching modules 204 (VASPS). MCU 202 is a multi-port device that allows intercommunication of three or more audio, audiographic, audiovisual or multimedia terminals in a conference configuration. VASPS modules 204, which each handles a separate conference in accordance with the embodiments of the present invention, are described in more detail with reference to FIG. 3. MCU 202 can support multiple conferences. Each VASPS module 204 supports a single conference. Features according to the present invention can be implemented within a VASPS module 204.

FIG. 3 shows a functional block diagram of an exemplary VASPS module 204, in accordance with an embodiment of the present invention. VASPS module 204 includes an incoming buffer 302, an energy comparator 304, an outgoing buffer 306 and a timing controller 308. Each of these components are preferably implemented in software, but can alternatively be implemented using hardware or a combination of hardware and software, as would be apparent to one of ordinary skill in the art.

As shown, VASPS module 204 supports a plurality of incoming and outgoing channels, wherein each incoming channel is associated with a corresponding output channel. For example, incoming channel 2 is associated with outgoing channel 2. Each incoming/outgoing channel pair supports a specific end user participating in a conference. For example, incoming channel 2 and outgoing channel 2 both support a single end user (e.g., end user 2) of the conference. Thus, three channel pairs are required to support three end users. Similarly, n channels pairs are required to support n end users. An end user is also referred to herein as a conference participant.

Each incoming channel receives incoming audio packets that can be in any one of a plurality of different formats. For example, each incoming packet can be a G.711 or G.723.1 formatted packet. G.711 and G.723.1 are voice compression algorithms standardized by the International Telecommunications Union (ITU). More specifically, G.711 is the international standard for encoding telephone audio on an 64 kbps channel. It is a pulse code modulation (PCM) scheme operating at a 8 kHz sample rate, with 8 bits per sample. Each G.711 packet represents 20 ms of voice data. G.723.1 is the international standard for encoding 8 kHz sampled speech signals for transmission at a rate of either 6.3 kbps or 5.3 kbps. G.723.1 encodes 240 sample frames (30 ms) of 16-bit linear PCM data into twenty four 8-bit code words for the 6.3 kbps rate or twenty 8-bit code words for the 5.3 kbps rate. Each G.723.1 packet represents 30 ms of voice data.

In FIG. 3, incoming audio packets are denoted P1(in), P2(in) . . . Pn(in). Similarly, outgoing packets are labeled P1(out), P2(out) . . . Pn(out). Packet P1(in) is received over incoming channel 1, packet P2(in) is received over incoming channel 2 . . . packet Pn(in) is received over incoming channel n. Similarly, packet P1(out) is transmitted over outgoing channel 1, packet P2(out) is transmitted over outgoing channel 2 . . . packet Pn(out) is transmitted over outgoing channel n.

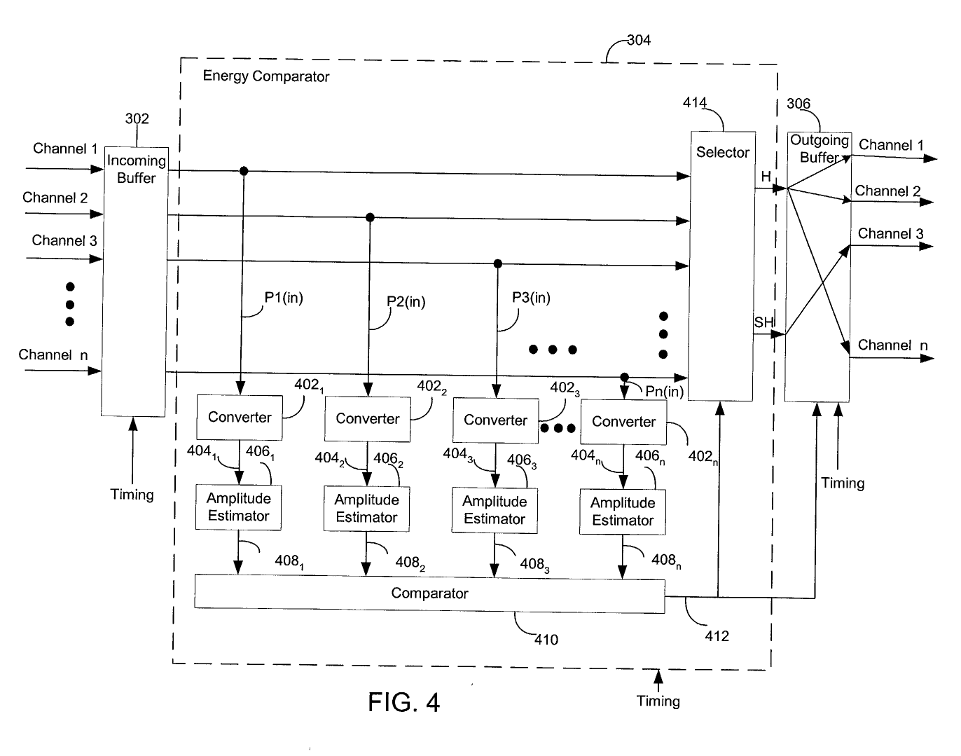

Optional incoming buffer 302 temporarily stores packets received over channels 1 through n prior to the packets being forwarded to energy comparator 304. Energy comparator 304, which is described in more detail with reference to FIG. 4, determines which incoming audio packet P1(in), P2(in) . . . Pn(in) has the highest energy level, and which has the second highest energy level. Energy comparator 304 then forwards the highest energy packets and the second highest energy packets to optional outgoing buffer 306. Energy comparator 306 also informs outgoing buffer 306 of which incoming channels received the highest energy packet and the second highest energy packet. This enables outgoing buffer 306, which temporarily stores outgoing audio packets for each outgoing channel P1 (out) through Pn(out), to forward the highest energy packets to all of the outgoing channels except the outgoing channels associated with the highest energy level incoming channel. This also enables outgoing buffer 306 to forward the second highest energy packets to the outgoing channel associated with the highest energy level incoming channel.

In one embodiment, all of the functions of outgoing buffer 306 are performed within energy comparator 304. Further, if incoming buffer 302 is not used, energy comparator 304 can receive packets directly from the incoming channels. In summary, the functional blocks described herein are somewhat arbitrarily defined for the convenience of describing features according to the present invention. Alternative boundaries can be drawn that are within the spirit and scope of the present invention.

Two things are accomplished by sending the second highest energy level packet (rather then the first highest energy level packet) over the outgoing channel associated with the highest energy incoming channel (i.e., the incoming channel over which the highest energy audio packet was received). First, this enables the loudest end user (i.e., conference participant) to hear the second loudest end user. Thus, the loudest speaker may choose to stop speaking so that the second loudest speaker becomes the loudest speaker and is heard by the rest of the end users of the conference. Second, this prevents the loudest speaker from hearing an echo, which can be annoying to the speaker.

Assume, for the example, that at a point in time the highest energy packet (e.g., P3(in)) is received over incoming channel 3, and the second highest energy packet (e.g., P1(in)) is received over incoming channel 1. In accordance with an embodiment of the present invention, the highest energy packet (received over incoming channel 3) will be sent over all outgoing channels except outgoing channel 3, as indicated by the functional arrows drawn within outgoing buffer 306. The second highest energy packet (received over incoming channel 1) will be sent over outgoing channel 3, as shown by a function arrow drawn within outgoing buffer 306.

Timing controller 308 triggers when incoming buffer 302, energy comparator 304 and outgoing buffer 306 perform their respective functions. For example, each of the functional blocks can be triggered every 10 ms, 20 ms or 30 ms. G.711 formatted packets contains 20 ms of audio data. Accordingly, if incoming packets P1 through Pn are G.711 packets, timing control 308 should trigger each functional block of FIG. 3 once ever 20 ms. G.723.1 formatted packets contain 30 ms of audio data. Accordingly, if the incoming packets are G.723.1 packets, timing controller 308 should trigger each functional block once every 30 ms.

Additional details of energy comparator 304 will now be described with reference to FIG. 4. As shown, energy comparator 304 receives packets P1(in), P2(in), P3(in) . . . Pn(in) from incoming buffer 302. Each of the packets are converted from a packet format (e.g., G.711 or G.723.1) to a linear digital format (e.g., 16-bit linear) by a respective converter 402₁, 402₂, 402₃ . . . 402ₙ. An amplitude of each linear signal 404₁, 404₂, 404₃ . . . 404ₙ is then estimated by a respective amplitude estimator 406₁, 406₂, 406₃ . . . 406ₙ.

For example, audio packets can be G.723.1 packets, each containing 24 bytes of audio data. Converters 402 can convert these packets to 16 bit-linear signals 404 that each include 240 separate 16-bit samples, with each sample representing an audio amplitude. Amplitude estimators 406 can then add the 240 separate 16-bit values to estimate the amplitude. Each estimated amplitude 408 is representative of the energy level of a received audio packet.

Estimated amplitudes 408 are then compared by a comparator 410. Comparator 410 identifies the highest energy packet and an associated incoming channel over which the highest energy packet was received. Comparator 410 also identifies the second highest energy packet and an associated further incoming channel over which the second highest energy packet was received. This information is provided to a selector 414 and outgoing buffer 306, for example, via a signal 412. Selector 414 selects the highest energy packet and the second highest energy packet and forwards it to outgoing buffer 306. Outgoing buffer 306, which knows what incoming channels the highest and second highest energy level packets were received over (e.g., incoming channel 3 and incoming channel 1, respectively), sends the highest energy packet (e.g., P3) to each of the n outgoing channels except the outgoing channel (e.g., outgoing channel 3) associated with incoming channel over which the highest energy packet was received. Outgoing buffer 306, sends the second highest energy packet (e.g., P1) to the outgoing channel (e.g., outgoing channel 3) associated with incoming channel over which the highest energy packet was received.

An advantage of this embodiment of the present invention is that conversions from linear audio signals (e.g., 16-bit linear) back to packets (e.g.,G.711 or G.723.1 encoded packets) are eliminated, significantly reducing the use of system resources. Additionally, audio mixing is eliminated. That is, the audio data of the packets that are sent to the outgoing channels are never mixed with audio data from other packets. This avoids audio distortion that can occur during mixing. This also significantly reduces processing time and the amount of system resources required to perform conferencing. Additionally, the voice quality is also significantly improved because each end user can only hear one channel's audio (e.g., voice) at one time.

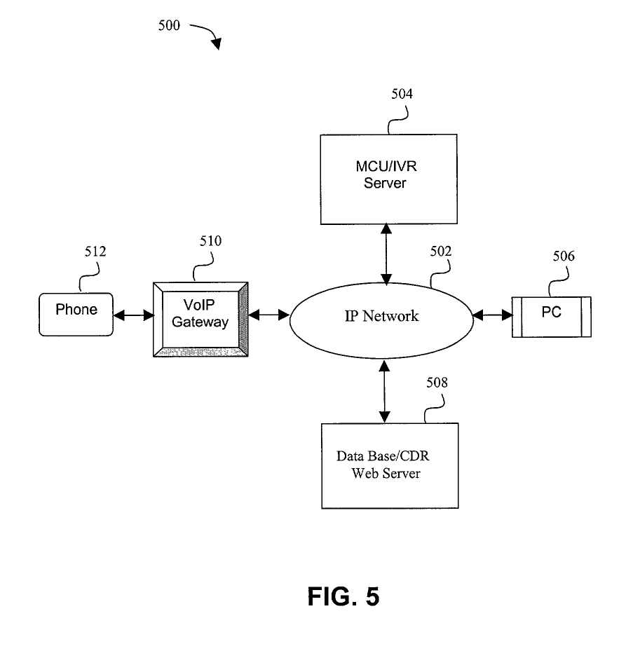

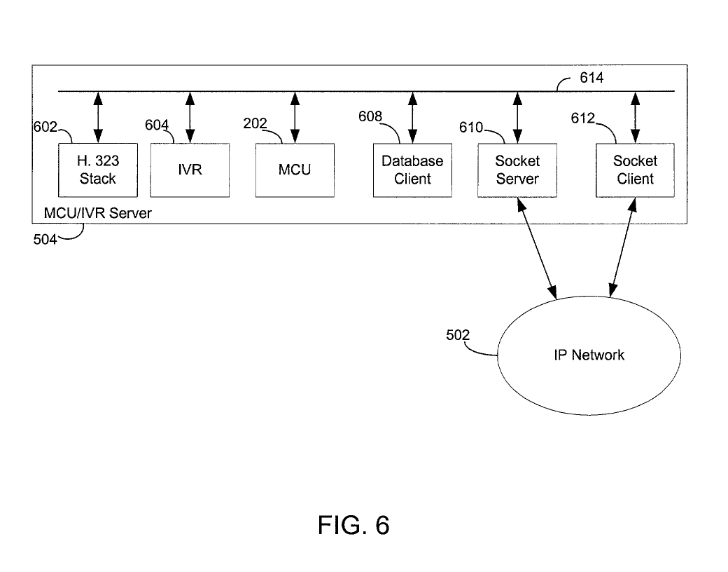

FIG. 5 illustrates an exemplary IP based audio conferencing (IPC) system 500 in which the present invention is useful. Exemplary IPC system 500 includes an IP network 502, which can be a local area network (LAN), but is more likely a wide are network (WAN). IP network 502 can also be the Internet or World Wide Web. Connected to IP network 502 are an MCU and interactive voice response (IVR) server 504 (additional details of which are described with reference to FIG. 6), a personal computer (PC) 506, and a database and call detail record (CDR) server 508. Additionally, a telephone 512 is shown as being connected to IP network 502 through a voice over IP (VoIP) gateway 510. VoIP gateway 510 converts analog audio signals received from telephone 512 to digital audio packets using a codec (e.g., an H.323 codec). PC 506 similarly converts analog audio signals to digital audio packets using an appropriate codec. Such digital audio packets are sent to MCU/IVR Server 504, which includes MCU 202 with VASPS modules 204. Referring to both FIG. 5 and FIG. 3, audio information originating from telephone 512 can be received, for example, over incoming channel 1, while audio information originating from PC 502 can be received over incoming channel 2. Additional audio information is received from other end users (not shown) that have access to IP network 502 to thereby participate in the conference. The highest energy packets or second highest energy packets are then sent to end users (e.g., of telephone 512 and PC 506), as appropriate. In this manner, conferencing in accordance with embodiments of the present invention can be accomplished.

FIG. 6 illustrates an exemplary embodiment of MCU/IVR server 504. As shown, in this embodiment MCU/IVR server 504 includes an H.323 protocol stack module 602, an IVR module 604, MCU 202 including a plurality of VASPS modules 204 (not shown in this figure), a database client 608, a socket server 610 and a socket client 612. Each of these blocks/modules are connected to a communications bus 614. Socket server 610 and socket client 612 are also connected to IP network 502.

H.323 protocol stack module 602 provides the foundation for data communications across IP network 502. H.323 protocol stack module can include, for example, parts of H.225.0-Registration, Admission, and Status (RAS), Q.931, H.245, real time protocol/real time control protocol (RTP/RTCP), audio codecs (e.g., G.711, G.723.1, G.729, etc.), and video codecs (e.g., H.261 and H.263) if desired. RAS manages registration, admission and status. Q.931 manages call setup and termination. H.245 negotiates channel usage and capabilities and transports dual tone multifrequency (DTMF) digits. Media streams can be transported using RTP/RTCP. RTP is used to carry the actual media and RTCP is used to carry status and control information. Signaling is transported reliably using transport control protocol (TCP).

Database client module 608 gets user information (e.g., account ID, PIN code, chair password, participant password, conference ID, and the like) from database/web server 508 (shown in FIG. 5) and sends conference information (e.g., setup conference chair password, setup conference participant password, call type, and the like) to database/web server 508.

Database/web server 508 can use socket client module 612 to send IPC control information (e.g., start recording, stop recording, invite someone to conferencing, hang up all, delete conference recording, and the like) to socket server module 610 of MCU/IVR server 504.

IVR module 604 manages IPC call flow, such as answering incoming calls, playing greeting messages, getting DTMF digits, creating conferencing, joining conferencing, inviting conferencing, and the like.

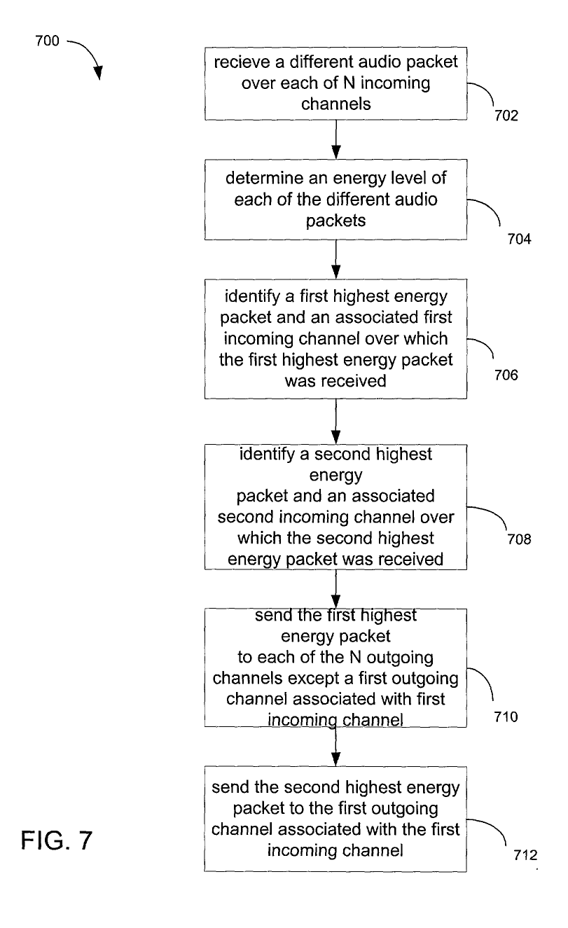

FIG. 7 is a flow diagram that is useful for describing a conferencing method 700 according to an embodiment of the present invention. This method 700 is for use in an environment including N incoming channels (where N≧3) and N outgoing channels. Each of the N incoming channels is associated with a corresponding one of the N outgoing channels.

At a step 702, a different audio packet is received over each of the N incoming channels. For example, referring back to FIG. 3, audio packets P1(in), P2(in), P3(in) . . . Pn(in) are received, respectively, over incoming channel 1, incoming channel 2, incoming channel 3 . . . incoming channel n. Each of the different audio packets, which is received from a different conference participant, can be, for example, a G.711 or G.723.1 encoded audio packet. These packets are optionally temporarily stored in incoming buffer 302, as shown in FIG. 3. Incoming buffer 302 can forward the packets to energy comparator 304 when appropriate. Additional details of a possible implementation for performing this step are discussed above with reference to FIGS. 3 and 4.

At a next step 704, an energy level is determined for each of the different audio packets. This can be accomplished, for example, by converting each audio packet to a linear signal and then estimating an amplitude of the linear signal. Such an estimated amplitude is representative of the energy level of a packet. In one embodiment, each audio packet is converted to a 16-bit linear signal. The energy level is estimated by adding the plurality of amplitudes associated with the 16-bit linear signal. Step 704 can be performed by energy comparator 304, which is discussed with reference to FIGS. 3 and 4. Additional details of an exemplary implementation for performing this step are provided in the discussion of those figures.

Next, at steps 706 and 708, a first highest energy packet (the packet having the highest energy) and a second highest energy packet (the packet having the next highest energy) are identified. Also identified at these steps are an associated first incoming channel over which the highest energy packet was received, and an associated second incoming channel over which the second highest energy packet was received. The terms “first” and “second” in the previous sentence are used to identify, respective, incoming channels over which the first highest and second highest energy packets were received, and do not necessarily refer to channel 1 and channel 2 of FIGS. 3 and 4. In other words, the “first incoming channel” over which the first highest energy packet was received can be, for example, incoming channel 3 of FIGS. 3 and 4. The “second incoming channel” over which the second highest energy packet was received can be, for example, incoming channel 1 of FIGS. 3 and 4. Additional details of an exemplary implementation for performing this step are discussed with reference to FIGS. 3 and 4.

Next, at a step 710 the highest energy packet (e.g., P3(in)) is sent to each of the N outgoing channels except a first outgoing channel (e.g., outgoing channel 3) associated with first incoming channel (e.g., incoming channel 3). At a step 712, the second highest energy packet (e.g., P1(in)) is sent to the first outgoing channel (e.g., outgoing channel 3) associated with the first incoming channel (e.g., incoming channel 3). Thus, referring to the example of FIGS. 3 and 4, all outgoing packets P1(out), P2(out) . . . . Pn(out), except P3(out) are equivalent to P3(in), if P3(in) is determined to be the highest energy packet. If P1(in) is determined to be the second highest energy packet, then P3(out) is equivalent to P1(in). Additional details of an exemplary implementation for performing this step are discussed above with reference to FIGS. 3 and 4.

The above steps are repeated such that the energy levels of incoming packets are continually or periodically compared to one another so that a decision can be made as to which specific packets are to be send out over which specific outgoing channels. Conferencing is accomplished in this manner.

It would be apparent to one of ordinary skill in the relevant art that some of the steps of method 700 discussed with reference to FIG. 7 need not be performed in the exact order described. For example, steps 706 and 708 can be performed simultaneously. However, it would also be apparent to one of ordinary skill in the relevant art that some of the steps must be performed before others. For example, steps 702 and 704 must be performed prior to steps 706 and 708. This is because steps 706 and 708 use the results of steps 702 and 704. The point is, the order of the steps is only important where a step uses results of another step. Accordingly, one of ordinary skill in the relevant art would appreciate that the present invention should not be limited to the exact order shown in FIG. 7.

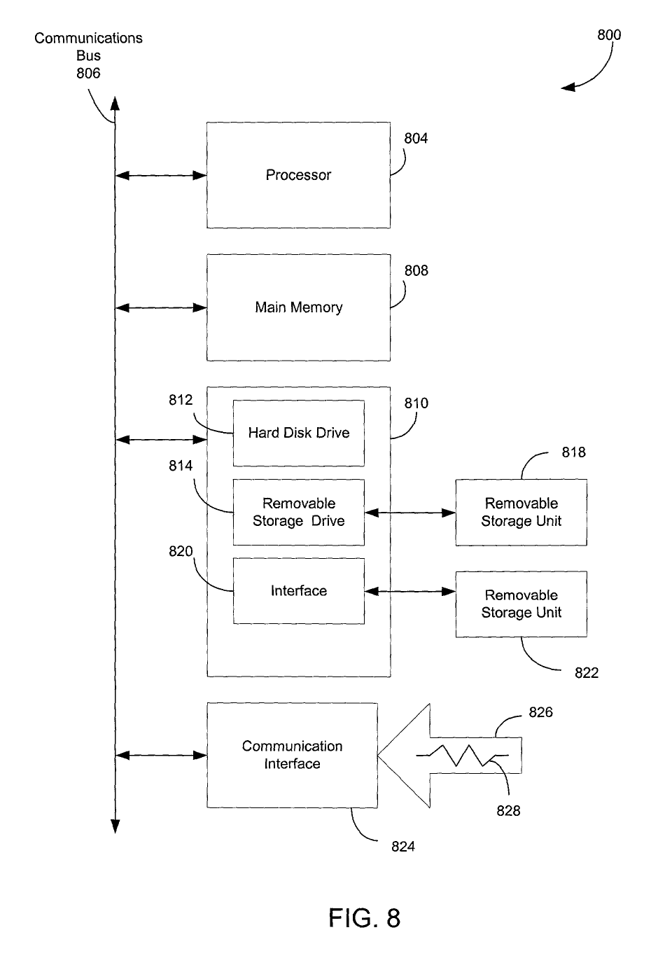

Many features of the present invention are performed using a computer system. Although implementation-specific hardware and/or software can be used to implement the present invention, the following description of a general purpose computer system is provided for completeness. The present invention can be implemented using software, hardware or a combination of hardware and software. Consequently, the invention may be implemented in a computer system or other processing system. An example of such a computer system 800 is shown in FIG. 8. Computer system 800 includes one or more processors, such as processor 804. Processor 804 is connected to a communication infrastructure 806 (for example, a bus or network). Various software implementations are described in terms of this exemplary computer system. After reading this description, it will become apparent to a person skilled in the relevant art how to implement the invention using other computer systems and/or computer architectures.

Computer system 800 also includes a main memory 808, preferably random access memory (RAM), and may also include a secondary memory 810. The secondary memory 810 may include, for example, a hard disk drive 812 and/or a removable storage drive 814, representing a floppy disk drive, a compact disk drive, a magnetic tape drive, an optical disk drive, etc. The removable storage drive 814 reads from and/or writes to a removable storage unit 818 in a well known manner. Removable storage unit 818, represents a floppy disk, a compact disk, magnetic tape, optical disk, etc. which is read by and written to by removable storage drive 814. As will be appreciated, the removable storage unit 818 includes a computer usable storage medium having stored therein computer software and/or data.

In alternative implementations, secondary memory 810 may include other similar means for allowing computer programs or other instructions to be loaded into computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 may also include a communications interface 824. Communications interface 824 allows software and data to be transferred between computer system 800 and external devices. Examples of communications interface 824 may include a modem, a network interface (such as an Ethernet card), a communications port, a PCMCIA slot and card, etc. Software and data transferred via communications interface 824 are in the form of signals 828 which may be electronic, electromagnetic, optical or other signals capable of being received by communications interface 824. These signals 828 are provided to communications interface 824 via a communications path 826. Communications path 826 carries signals 828 and may be implemented using wire or cable, fiber optics, a phone line, a cellular phone link, an RF link and other communications channels.

In this document, the terms “computer program medium” and “computer usable medium” are used to generally refer to media such as removable storage drive 814, a hard disk installed in hard disk drive 812, and signals 828. These computer program products are means for providing software to computer system 800.

Computer programs (also called computer control logic) are stored in main memory 808, secondary memory 810, and/or removable storage units 818, 822. Computer programs may also be received via communications interface 824. Such computer programs, when executed, enable computer system 800 to implement the present invention as discussed herein. In particular, the computer programs, when executed, enable the processor 804 to implement the features of the present invention. Where the invention is implemented using software, the software may be stored in a computer program product and loaded into computer system 800 using removable storage drive 814, hard drive 812 or communications interface 824.

Features of the invention may also be implemented primarily in hardware using, for example, hardware components such as application specific integrated circuits (ASICs). Implementation of the hardware state machine so as to perform the functions described herein will be apparent to persons skilled in the relevant art(s).

In yet another embodiment, features of the invention can be implemented using a combination of both hardware and software.

The present invention provides improved audio conferencing over data networks, such as an IP network. The present invention can also provide a useful tool for software developers to develop audio conferencing type applications.

While various embodiments of the present invention have been described above, it should be understood that they have been presented by way of example, and not limitation. It will be apparent to persons skilled in the relevant art that various changes in form and detail can be made therein without departing from the spirit and scope of the invention.

The present invention has been described above with the aid of functional building blocks illustrating the performance of specified functions and relationships thereof. The boundaries of these functional building blocks have been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

The breadth and scope of the present invention should not be limited by any of the above-described exemplary embodiments, but should be defined only in accordance with the following claims and their equivalents.

What is claimed is:

1. A conferencing method for use in an environment including N incoming channels and N outgoing channels, where each of the N incoming channels is associated with a corresponding one of the N outgoing channels, and where N≧3, the method comprising:
(a) receiving a different audio packet over each of the N incoming channels;
(b) determining an energy level of each of the different audio packets;
(c) identifying a first highest energy packet and an associated first incoming channel over which the highest energy packet was received;
(d) identifying a second highest energy packet and an associated second incoming channel over which the second highest energy packet was received;
(e) sending the first highest energy packet to each of the N outgoing channels except a first outgoing channel associated with first incoming channel; and
(f) sending the second highest energy packet to the first outgoing channel associated with the first incoming channel.

2. The method of claim 1, further comprising repeating steps (a) through (f) a plurality of times.

3. The method of claim 2, wherein each audio packet comprises a G.711 encoded audio packet.

4. The method of claim 3, wherein all of steps (b) through (f) are performed once every 20 ms.

5. The method of claim 2, wherein each audio packet comprises a G.723.1 encoded audio packet.

6. The method of claim 5, wherein all of steps (b) through (f) are performed once every 30 ms.

7. The method of claim 1, wherein each of the different audio packets is received from a different conference participant.

8. The method of claim 1, wherein for each of the different audio packets step (b) comprises:
(b.1) converting the audio packet to a linear signal; and
(b.2) estimating an amplitude of the linear signal, the amplitude being representative of the energy level.

9. The method of claim 8, wherein:
step (b.1) comprises converting the audio packets to a 16-bit linear signal; and
step (b.2) comprises adding a plurality of amplitudes associated with the 16-bit linear signal.

10. The method of claim 8, wherein step (c) comprises identifying the first highest energy packet and the associated first incoming channel based on the amplitudes estimated at step (b).

11. The method of claim 10, where step (d) comprises identifying the second highest energy packet and the associated second incoming channel based on the amplitudes estimated at step (b).

12. A computer program product comprising a computer useable medium having computer program logic recorded thereon for enabling a processor to perform conferencing in an environment including N incoming channels and N outgoing channels, where each of the N incoming channels is associated with a corresponding one of the N outgoing channels, and where N≧3, the computer program logic comprising: means for enabling the processor to determine an energy level of each of N different audio packets, each of the N different audio packets received over a respective one of the N incoming channels;
means for enabling the processor to identify a first highest energy packet and an associated first incoming channel over which the highest energy packet was received;
means for enabling the processor to identify a second highest energy packet and an associated second incoming channel over which the second highest energy packet was received;
means for enabling the processor to send the first highest energy packet to each of the N outgoing channels except a first outgoing channel associated with first incoming channel; and
means for enabling the processor to send the second highest energy packet to the first outgoing channel associated with the first incoming channel.

13. A conferencing system for use in an environment including N incoming channels and N outgoing channels, where each of the N incoming channels is associated with a corresponding one of the N outgoing channels, and where N≧3, the system comprising:
means for determining an energy level of each of N different audio packets, each of the N different audio packets received over a respective one of the N incoming channels;
means for identifying a first highest energy packet and an associated first incoming channel over which the highest energy packet was received;
means for identifying a second highest energy packet and an associated second incoming channel over which the second highest energy packet was received;
means for sending the first highest energy packet to each of the N outgoing channels except a first outgoing channel associated with first incoming channel; and
means for sending the second highest energy packet to the first outgoing channel associated with the first incoming channel.

14. A conferencing system for use in an environment including N incoming channels and N outgoing channels, where each of the N incoming channels is associated with a corresponding one of the N outgoing channels, and where N≧3, the system comprising:
an incoming buffer to receive a different audio packet over each of the N incoming channels;
an energy comparator to
determine an energy level of each of N different audio packets,
identify a first highest energy packet and an associated first incoming channel over which the highest energy packet was received, and
identify a second highest energy packet and an associated second incoming channel over which the second highest energy packet was received; and
an outgoing buffer to
send the first highest energy packet to each of the N outgoing channels except a first outgoing channel associated with first incoming channel, and
send the second highest energy packet to the first outgoing channel associated with the first incoming channel.
